(19) United States
(12) Patent Application Publication
(10) Pub. No.: US 2009/0052843 A1
(43) Pub. Date: Feb. 26, 2009

(54) Optical Multi-Fiber Plug Connection

(76) Inventors: Loic Cherel, Annecy (FR); Aaron Rossetto, Gordola (CH); Francois Caloz, Arcegno (CH)

Correspondence Address: THE NATH LAW GROUP, 112 South West Street, Alexandria, VA, 22314, US

(21) Appl. No.: 11/988,721

(22) PCT Filed: Jul. 15, 2005
(86) PCT No.: PCT/EP2005/053421

§ 371 Date: May 8, 2008

(51) Int. Cl. G02B 6/38; G01N 21/00; G01B 11/02

(52) U.S. Cl. 385/59; 356/73.1; 356/511

(57) ABSTRACT

The invention relates to a plug connection for a mobile optical multi-thread plug part (2, 3) which comprises various adaptive means. The adaptive section (PA1) of the first adaptive means (6, 8) is longer than the adaptive section (PA2) of the second adaptive means (7, 9) in relation to the longitudinal axis thereof. The adaptive means (6, 7, 8, 9) are embodied in such a manner that initially the first adaptive means (6, 8) and then the second adaptive means (7, 9), after surpassing an insertion path, can be impinged upon by associated guiding means of the plug part, when the plug part (2, 3) is inserted.

The invention relates to a plug connection for producing an optical plug connection to an optical multiple-fiber plug part as claimed in the precharacterizing clause of claim 1, and to an interferometer having a plug connection such as this. Plug connections such as these are used primarily for connection of optical multiple-fiber plug parts which have a plurality of optical waveguides which are arranged parallel and in one or more rows, and whose ends are held on an end surface. So-called MT plugs such as these are subject to stringent manufacturing tolerance requirements. It must therefore always be possible to align an MT plug and its plug mating piece exactly with respect to one another. Interferometers are used to test the plugs.

A plug connection which is comparable in terms of its generic type has been disclosed, for example, in US 2004/0013394 A1. A plate with appropriate matching means is provided for connection of male and female plug parts to an interferometer. This plate is connected to a larger holding plate which can itself be attached to a housing wall of an interferometer. The holding plate has an opening for part of the plug part to pass through. For connection of female plug parts, the plate as the matching means has two cylindrical plug pins. In practice, it has been found that so-called over-guiding can occur as a result of the specific requirements for the material and geometry of the multiple-fiber plug parts and the plug connection. In the extreme case, this can even lead to mechanical jamming occurring during the connection process. This obviously greatly delays the measuring process when a large number of plug parts have to be measured. have a relief-like constriction in the center, thus resulting in a cylindrical section at the front end and at the rear end. However, in practice, it has been found that even this plug connection may result in problems during connection of plug parts.

One object of the present invention is therefore to avoid the disadvantages of the known, and in particular to provide a plug connection and an interferometer of the type mentioned initially by means of which or in the case of which plug parts can advantageously be connected. The aim is to avoid over-guiding. The aim is therefore to design the plug connection such that even plug parts with unavoidable tolerance discrepancies can be held easily and at the same time precisely. A further aim, overall, is to improve the handling of the interferometer and in particular to allow repeated connection and disconnection without any problems. According to the invention, this object is achieved by a plug connection which has the features of claim 1.

The different designs of the first and second matching means result in the complementary guide means of the plug part being acted on in different ways during the connection process. Over-guiding or tilting can be avoided by the choice of different longitudinal extents for the matching sections of the matching means. Over-guiding during connection is precluded in this way. The matching means of the plug connection may be composed of ceramic material or of any other very hard material such as hard metal.

Alternatively or additionally, the matching means of the plug connection may be designed such that, during insertion of the plug part, the associated guide means of the plug part first of all act on the first matching means and act on the second matching means only after an insertion distance has been exceeded, in order to form a fit. This considerably simplifies the process of connection of a plug part.

The first matching means of the plug connection may be designed such that the complementary guide means of the plug part can be held with an accurate fit over approximately the entire insertion depth. The first matching means is therefore used to produce a first reference position. The first matching means could therefore be used to hold a plug part such that it fits, except for the precise angular position. The second matching means would therefore essentially just have to additionally fix the precise angular position of the plug part with respect to the axis of the first guide means or of the first matching means.

A male embodiment of a plug part may have two essentially cylindrical guide pins as guide means. For a male plug part such as this, the first matching means of the plug connection may be a matching hole in order to hold the complementary guide pin, by which means the guide pin of the plug part can be held with an accurate fit over approximately the entire insertion depth. The second matching means may have an opening in order to hold the complementary guide pin, whose internal contour has a concave longitudinal section, thus defining an approximately linear contact with the complementary guide pin. For this purpose, by way of example, the internal contour could have a circular shape in the longitudinal section. The matching section for the complementary guide pin would in this case be predetermined by the narrowest point. These arrangements avoid over-guiding, in a virtually ideal manner, during connection of a male plug part to the plug connection. Instead of having a curved shape, the internal contour of the opening may also have a cylindrical section, thus defining a contact surface with the complementary guide pin. This embodiment has the advantage that it can be produced relatively easily, for example by milling and drilling operations.

In one alternative embodiment for a plug connection for a male plug part with essentially cylindrical guide pins, the second matching means may have an opening which, for simple insertion of the guide pin, has a cylindrical insertion section which, together with the outer casing of the guide pin defines an annular gap. The insertion section has a second section adjacent to it, in which, in a limit position, the complementary guide pin can be held with an accurate fit. A tapering section which, for example, is conical, may be formed between the second section, which forms the matching section, and the insertion section. This arrangement has the advantage that it ensures advantageous insertion of the plug part into the plug connection during the connection process.

A female plug part may be provided with guide holes which are complementary to the guide pins on the male plug part. A male plug part and an associated female plug part can be joined together to form a plug connection. A plug connection for a female plug part with guide holes in the plug part may be distinguished in that the matching means which are complementary to the guide holes are matching pins, with the second matching pin being shorter than the first matching pin. The length of the matching pins is in this case advantageously measured from the end face of the plug connection. An arrangement such as this ensures in a simple way that the associated guide means (guide hole) in the plug part can act first of all on the first matching means and act on the second matching means only after an insertion distance has been exceeded.

The length of the second matching pin may be at most 90%, preferably at most 70%, and particularly preferably at most 50%, of the length of the first matching pin with respect to the end face. This allows the connection process to be carried out in a particularly advantageous manner.

It may be advantageous for the first matching pin of the plug connection to be essentially cylindrical. The first matching pin may, of course, taper conically for simpler insertion. The second matching pin may have a head part which forms the free end of the matching pin. This head part can be held with an accurate fit in the complementary guide hole in the female plug part. It may be particularly advantageous for the second matching pin to have a taper at least between the head part and the end face of the plug connection.

The second matching pin may have a holding section which is adjacent to the taper. The taper would therefore be arranged between the head part and the holding section. In this case, the holding section may be cylindrical, with its diameter preferably corresponding to the (largest) diameter of the head part. This would result in a plug pin which can be held, preferably with an accurate fit, in a corresponding opening in a simple manner for attachment to a base plate.

The head part may be approximately dome-shaped or be spherical, thus defining a preferably approximately linear contact with the complementary guide hole. However, the head part could also have a cylindrical section, thus defining an area contact with the complementary guide hole in the female plug part. For this purpose, the head part could have an approximately trapezoidal configuration in its longitudinal section. However, other configurations are also feasible, of course.

The plug connection may have a base plate in order to fix the matching means. This base plate defines the end face for making contact with the end face of the plug part. This end face may be used as a reference for the measurement or calibration, as described above, of the plug part with the aid of an interferometer. Furthermore, the base plate may also define the insertion depth for the complementary guide means of the plug part.

In order to ensure high precision and manufacturing quality, the base plate may be composed of metallic material, for example hard metal. However, a different very hard material, for example hard metal, would also be feasible.

The aspect of the invention described above describes an arrangement which can essentially fix the precise angular position of the plug part in the plug connection. This angular position may also be defined by an X direction which runs at right angles to the connecting line between the axes of the matching means. In practice, it has been found that tolerance discrepancies which are virtually unavoidable in practice can lead to problems during connection of the plug parts into the plug connection.

In order to solve this problem, the base plate may have an elastic section which is associated with at least one of the matching means, which is designed to be elastic such that, during connection of a plug part, the matching means can be moved in the y-direction in order to compensate for dimensional discrepancies between the guide means. This makes it possible to compensate for dimensional discrepancies between the guide means of the plug parts, in a simple manner. In this case, the y-direction runs at right angles to the longitudinal axis of the matching means of the plug connection, and is defined by the connecting line between the two axes. An x-direction may run at right angles to the y-direction along the end face of the base plate. In consequence, a z-direction could run in the direction of one axis of the matching means. The principle using an elastic section is known, for example, in conjunction with the connection of two plug parts from CH 690 310 A5.

The base plate may have a reference opening arranged in a relatively fixed manner in order to fix either the first or the second matching means. A second opening may be provided for the other matching means, and is arranged in an elastic section. In this case, in the case of a plug connection for a male plug part, the reference opening and the second opening would define the matching means for holding the complementary guide pins of the plug part. In the case of a plug connection for a female plug part, matching pins could be inserted with fairly accurate fits into the reference opening and the second opening. By way of example, the guide pins could be inserted into the reference opening or second opening with a force fit and/or with the aid of adhesive.

A cutout for holding a coupling section of the plug part may be provided between the reference opening and the second opening in the base plate, with the ends of the optical waveguides being held in this plug part. In this case, the coupling section could be arranged on an absolutely flat end face of the plug part. However, it is also feasible for the coupling section to form a strip which overhangs the rest of the end face. One such coupling section is disclosed, for example, in CH 690 310 A5. In order to achieve the elastic section, either the reference opening or the second opening may be connected to the cutout via a gap, and the opposite side of this opening may be bounded by a gap section. This results in an advantageous configuration of the elastic section which, for example, can flex if the distance between the matching means is oversize.

In order to achieve the elastic section, the second opening may be arranged between a gap arrangement which is formed by a longitudinal gap and a gap section parallel to it. In this case, the longitudinal gap and the gap section would advantageously run in the x-direction.

The longitudinal gap and the gap section may be of approximately the same length in the x-direction, with their lengths being at least twice the diameter of the second opening.

A compensation cutout may be arranged, on each of the two sides of the second opening, between the longitudinal gap and the gap section, thus forming narrow webs which run in the x direction. In this embodiment, the elastic section has an approximately H-shaped configuration. An H arrangement such as this allows optimum compensation for dimensional discrepancies. In the event of compensation movements, the webs, which are preferably aligned parallel to one another, would be aligned like a parallelogram. An H-shaped configuration such as this could also be used for conventional plug connections. Conventional plug connections are considered to be connections whose matching means are identical. This configuration could therefore in its own right form an autonomous subject matter of an invention. However, of course, it would also be feasible to design the elastic section in a similar manner to that in CH 690 310 A5. For example, either the reference opening or the second opening could be surrounded by two approximately U-shaped slots which are pushed into one another, facing in opposite directions.

A cutout which is intended to hold a coupling section of the plug part may be adjacent to the gap section. An arrangement such as this may be advantageous for manufacturing reasons.

The second opening may be connected via a gap to a cutout which is intended to hold a coupling section of the plug part. An arrangement such as this may be advantageous for manufacturing reasons.

A further aspect of the invention relates to an interferometer for measuring the surface topography of the end face of male and/or female multiple-fiber plug parts. An interferometer such as this may have at least one plug connection according to an embodiment as described above.

Further advantages and detailed features of the invention will become evident from the drawings and from the following description of exemplary embodiments. In the figures:

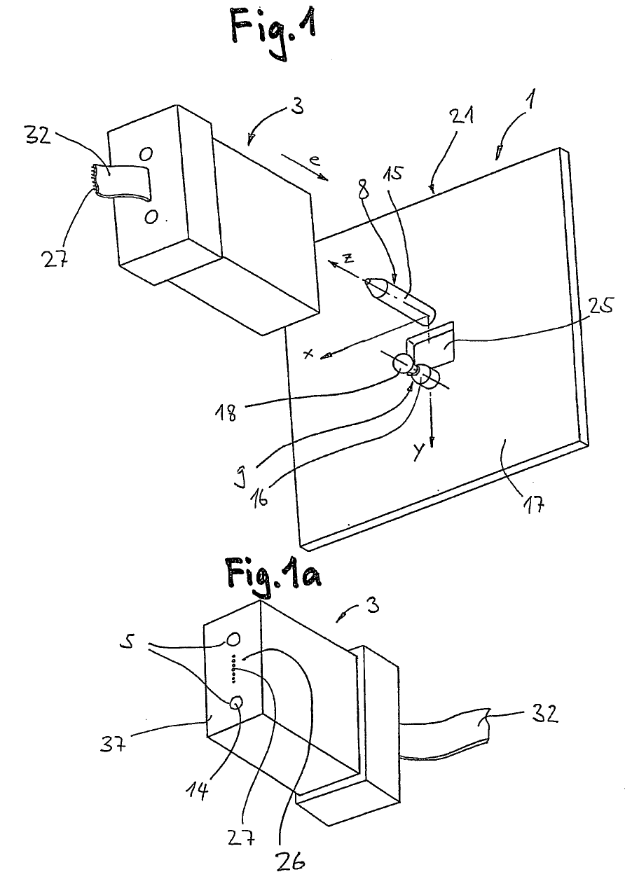

FIG. 1 shows a perspective illustration of a plug connection according to the invention for a female plug part,

FIG. 1a shows the plug part shown in FIG. 1, in the form of a perspective illustration from the front,

FIG. 2 shows a side view of the plug connection as shown in FIG. 1, with a plug part, shortly before the connecting process,

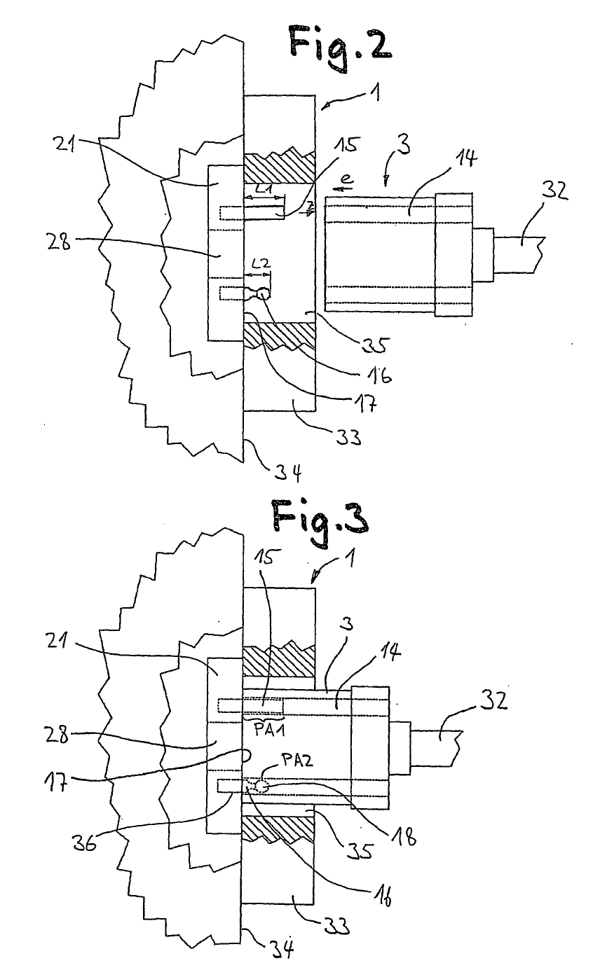

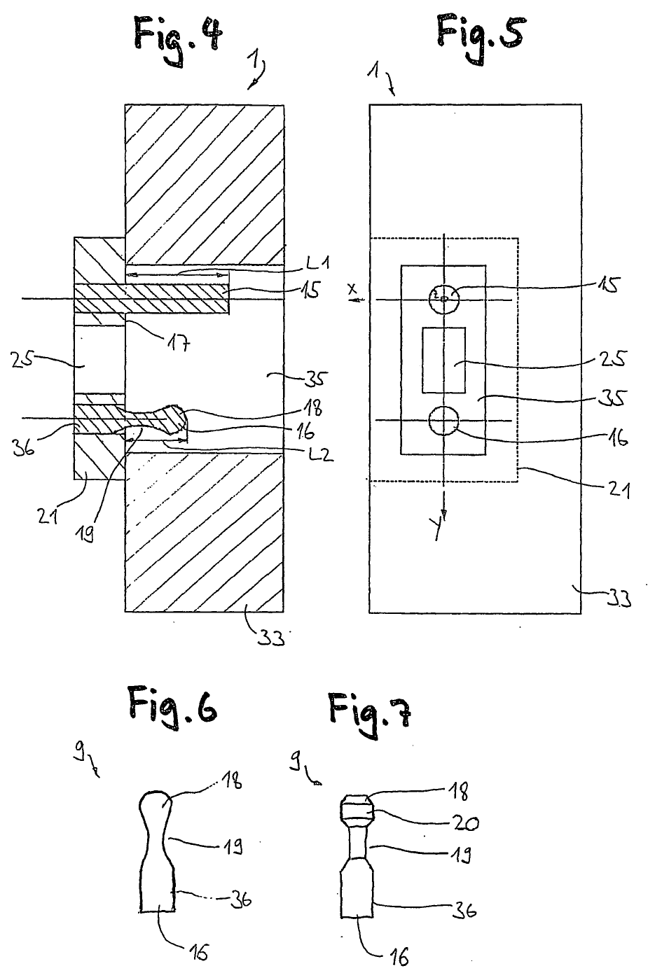

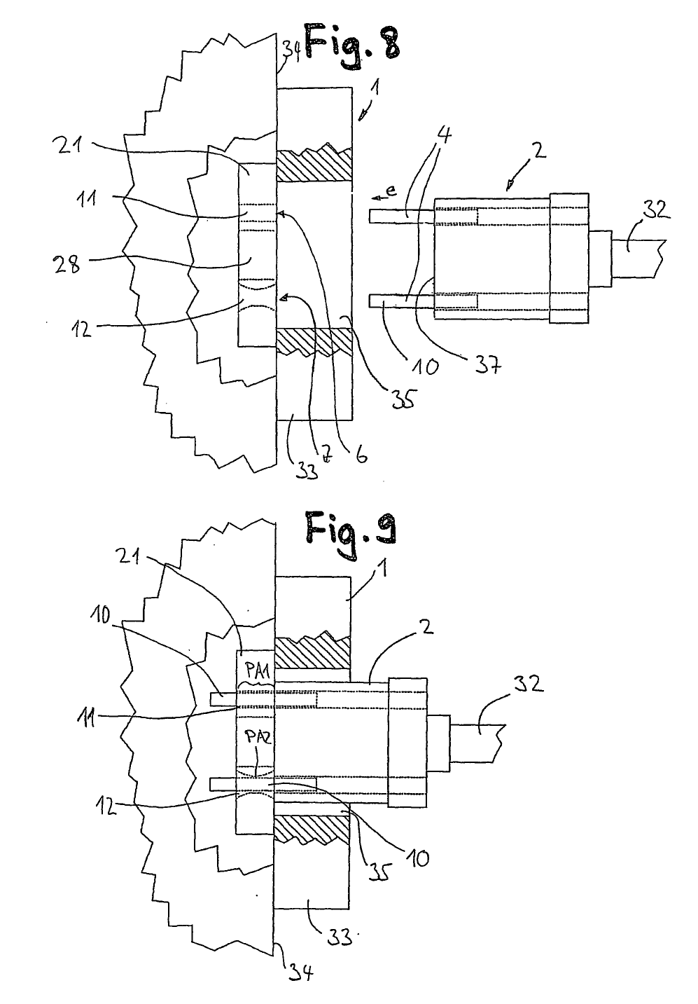

FIG. 3 shows the plug connection as shown in FIG. 2 with the plug part connected,

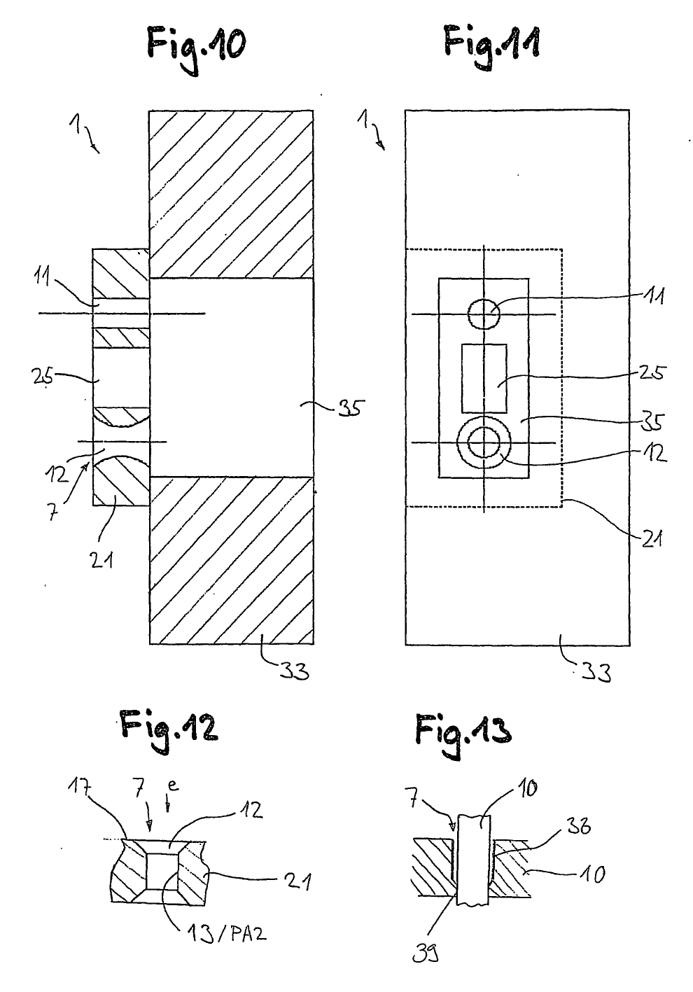

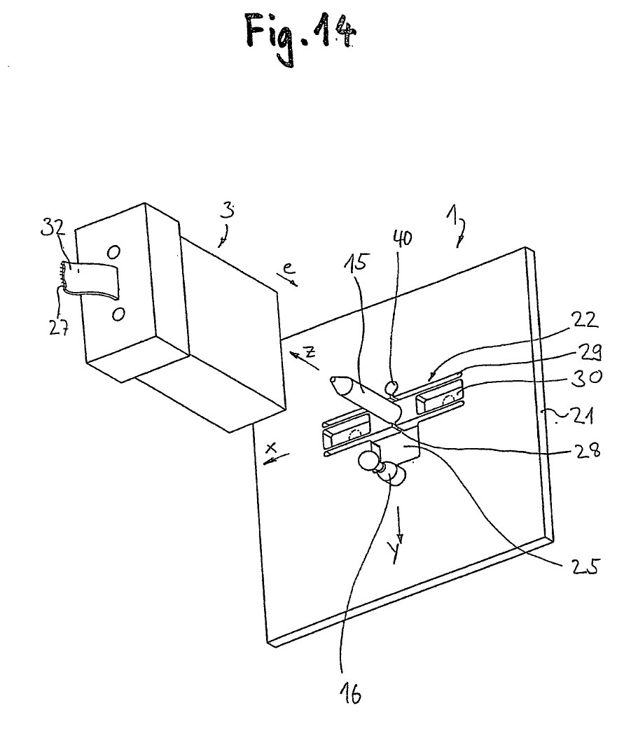

FIG. 4 shows a cross section through a plug connection,

FIG. 5 shows a plan view of the plug connection shown in FIG. 4,

FIG. 6 shows the matching pin as shown in FIG. 4,

FIG. 7 shows an alternative embodiment of the matching pin as shown in FIG. 6,

FIG. 8 shows a side view of a plug connection for a male plug part shortly before the connecting process,

FIG. 9 shows the plug connection shown in FIG. 8 with the plug part connected,

FIG. 10 shows a cross section through a plug connection for a male plug part,

FIG. 11 shows a plan view of the plug connection shown in FIG. 10,

FIG. 12 shows an alternative embodiment of the concave opening shown in FIG. 10,

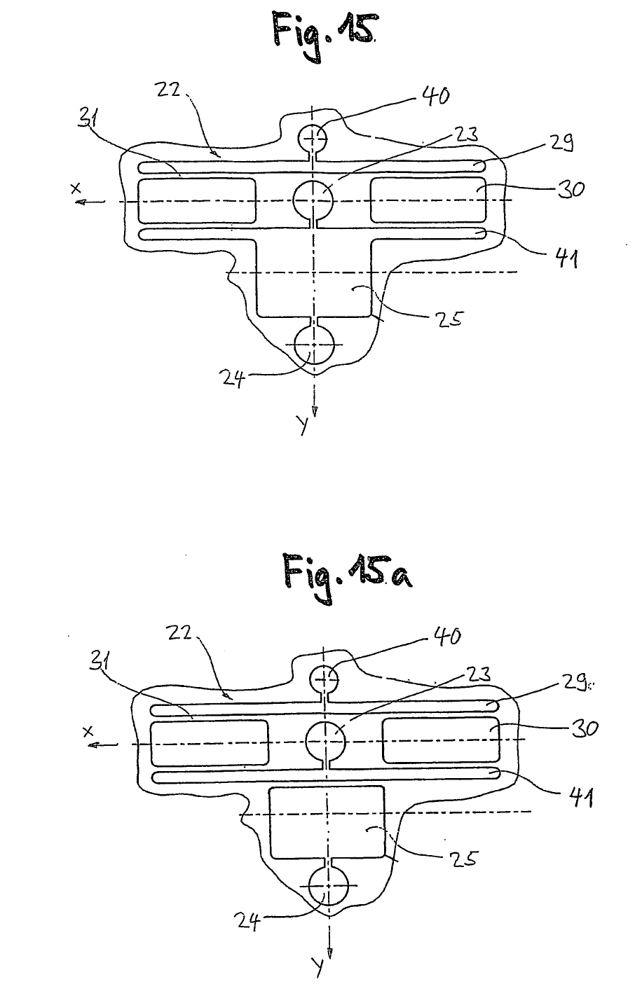

FIG. 13 shows a further embodiment of an opening for a plug pin,

FIG. 14 shows a perspective illustration of a further plug connection for a female plug part with an elastic section,

FIG. 15 shows a detail from a front view of the base plate shown in FIG. 14,

FIG. 15a shows an alternative embodiment of the base plate shown in FIG. 15,

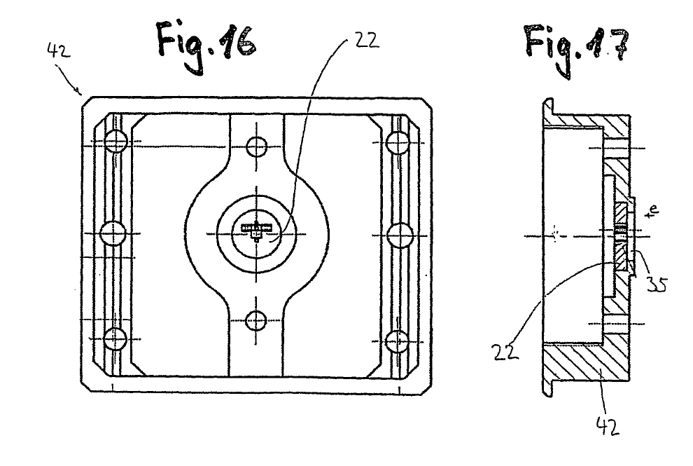

FIG. 16 shows an end view and front view of a plug connection for an interferometer, and,

FIG. 17 shows a cross section through the plug connection shown in FIG. 16.

As shown in FIG. 1 a plug connection which is annotated 1 contains two matching means 8 and 9 which are arranged at a distance from one another and run parallel. The plug part 3, shown at the front in FIG. 1a, has guide means 5 which are complementary to the matching means and are in the form of guide holes 14. A plug part 3 such as this is also referred to as a female plug. In order to connect the plug part 3, it is inserted in the e-direction by insertion of the guide holes into the matching means 8 and 9.

As can be seen, the matching means 8 and 9 are designed differently. The first matching means 8 is an essentially cylindrical guide pin 15, whose front end is pointed. A point such as this simplifies the insertion process, but is not absolutely essential. However, it is essential that the complementary guide hole of the plug part 3 can be held with an accurate fit in the matching pin 15. The second matching means 9 is a matching pin 16 which has a spherical head part in order to hold it with an accurate fit in the other guide hole 5. These two plug pins 15 and 16 are advantageously composed of ceramic material, or of any other very hard material.

The plug pins 15 and 16 (of matching means 8 and 9) project at right angles away from a base plate 21. This base plate defines an end face 17 which may be used as a reference surface for an interferometer (which is not shown) (FIG. 2). This end face 17 is used as a contact surface for an end surface of the plug part 3. This end surface is annotated 37 in FIG. 1a. The closure body, which forms the end surface 37, of the plug part 3 may likewise be composed of a ceramic material.

FIG. 1a shows the female plug part 3 from the front. As can be seen, this has a plurality of optical waveguides 27, which end in a coupling section on the absolutely flat end surface 37. Plug parts such as these are also known and are in use as MT plugs. It would, of course, also be feasible, for example as described in CH 690 310 A5, for the coupling section to be arranged on a strip which overhangs the end surface. In the inserted or connected state, the light that is fed in will be passed through a cutout 25 (FIG. 1).

As FIG. 2 shows, the matching pins 15 and 16 have different lengths with respect to the end face 17. The cylindrical matching pin 15 in this case projects with a length L1 in the z-direction out of the base plate 21. The shorter plug pin 16 has a length L2. This means that, during insertion of the plug part 3, the associated guide hole 14 first of all acts on the first plug pin 15 and acts on the second plug pin 16 only after an insertion distance (L1-L2) has been exceeded. This allows the insertion process to be carried out particularly easily.

FIG. 2 also shows that the base plate 21 is connected to a holding plate 33. This holding plate 33 is itself attached to a housing wall 34, for example of an interferometer. The holding plate 33 has a recess 35 for insertion of the plug part 3. A plug connection which is comparable in terms of its generic type for an interferometer is described in detail, for example in US 2004/0013394 A1.

In FIG. 3, the plug part 3 shown in FIG. 2 is connected to the plug connection 1 and is in a limit position. As can clearly be seen, the first matching pin 15 is held with an accurate fit over the entire insertion depth in the complementary guide hole 14 in the plug part 3. The corresponding matching section to make the contact with the guide hole is annotated PA1. The other fit is distinguished in that the fit is essentially formed by the head part 18. If the head part 18 is spherical, an approximately linear contact is formed with the complementary hole 14. The matching section PA2 of the second matching pin 16 is, as can be seen, very much shorter than PA1 of the first matching pin 15. A further matching section may be provided in the area of the end face 17, and is defined by a cylindrical holding section 36. However, this additional matching section (as shown for example in the following FIG. 4) is not essential.

As can be seen from FIG. 4, the matching pins 15 and 16 have been inserted into corresponding holes in the base plate 21. The shorter matching pin 16 has an approximately spherical head part 18 and a holding section 36. A taper 19 is provided between the head part 18 and the holding section 36. The holding section 36 of the matching pin 16 is inserted with an accurate fit into a corresponding hole in the base plate 21, and is advantageously additionally connected to it by adhesive bonding. In general, this likewise applies to the plug pin 15. One specific refinement of the base plate with openings (or holes) is described in the following FIGS. 14 to 15.

The matching pin 16 shown in FIG. 4 prevents over-guiding in the connecting process of a plug part, in a virtually ideal manner. The matching pin 16 is positioned just with the aid of a virtually linear contact surface, which is defined by the head part 18. This can likewise be seen from the end view shown in FIG. 5. The matching pin 16 essentially fixes only the precise angular position of the female plug part, since the cylindrical matching pin 15 can be regarded as a reference pin. The base plate is arranged exactly at the edge of the holding plate 33.

FIG. 6 once again shows the matching pin 16, in the form of a separate component. FIG. 7 shows a different embodiment of a matching pin 16, whose head part 18 has an approximately trapezoidal longitudinal section. This results in a cylindrical section 20 which would define an area contact with the complementary guide hole. Other configurations are, of course, also feasible for the head part 18.

FIG. 8 shows a plug connection 1 for a male plug part 2. This plug part 2 is designed to be complementary to the female plug part, as has been described above. An optical plug connection would be formed by joining the female and male plugs together. However, a plug connection 1 for an interferometer is shown in the present case.

As the guide means 4, the male plug part 2 has two guide pins 10 which run parallel and are arranged at a distance from one another. As can be seen, they are cylindrical. Openings are provided in the base plate 21 of the plug connection 1 as matching means for holding the complementary guide pins 10 with an accurate fit. The first matching means 6 is a matching hole 11. The second matching means 7 is an opening 12, whose internal contour is concave, in a longitudinal section.

As can be seen from FIG. 9, the concave configuration defines an approximately linear contact with the complementary guide pin 10. The corresponding matching section is annotated PA2. With a different fit, or in the case of a matching hole 11, the guide pin 10 is held with an accurate fit in the matching means over its entire insertion depth. The corresponding matching section PA1 therefore corresponds approximately to the thickness of the base plate 21.

Apart from this, the basic design of the plug connection 1 for a male plug part corresponds essentially to the design of a connection for a female plug part. As can be seen in FIGS. 10 and 11, the plug connection may be designed in the same manner for a male plug part, except for the different type of configuration of the matching means. Reference is therefore made to the description of the figures, as above.

FIG. 10 shows one particular advantageous refinement of the second matching means 7, which may have a concave internal contour as the opening 12. It is particularly advantageous for this to have a circular shape, in a longitudinal section. As FIGS. 12 and 13 show, different configurations of the second matching means 7 are, however, also feasible. For example, FIG. 12 shows an opening 12 whose internal contour has a cylindrical section 13 which forms a contact surface with the complementary guide pin or a matching section PA2. As can be seen in FIG. 13, the matching means 7 may have a cylindrical insertion section 38 which, together with the outer casing of the guide pin 10, forms an annular gap. A second cylindrical section 39 may be provided adjacent to the insertion section, in which the guide pin can be held with an accurate fit.

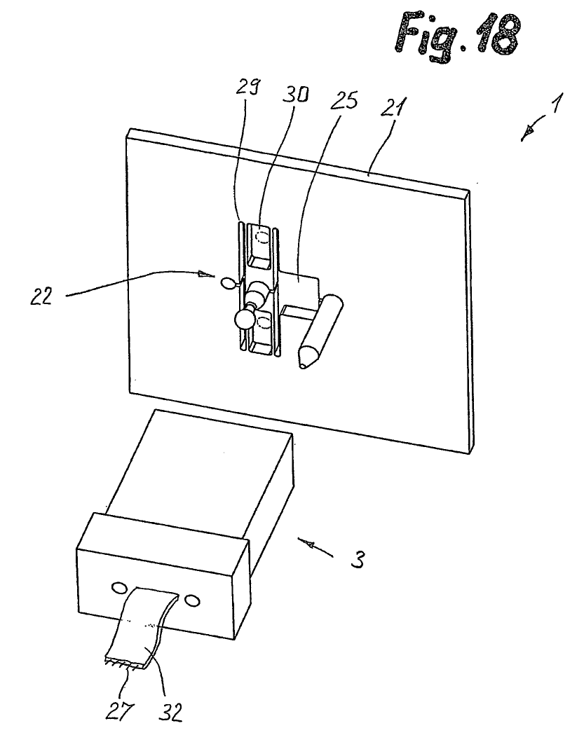

In contrast to FIG. 1, the plug connection shown in FIG. 14 has a base plate 21 which can flex in the y-direction—even if only to a minimal extent. An elastic section 22 is provided for this purpose and has an approximately H-shaped configuration. In the present case, the first matching pin 15, which is intended to be used as a reference pin and is essentially cylindrical, is associated with the elastic section 22. The second matching means or the second matching pin 16 is inserted in the reference opening, in a relatively fixed manner. An opposite arrangement is, of course, also feasible, that is to say with the second matching pin in this case being associated with the elastic section. This embodiment is shown in a particularly advantageous form in FIG. 18.

The precise configuration of this arrangement can be seen in FIG. 15. A reference opening 23 is provided for the cylindrical plug pin and can hold the matching pin with an accurate fit, with the matching pin additionally advantageously being adhesively bonded in it. In order to achieve the elastic section 22 in order to compensate for dimensional discrepancies between the matching pins, a longitudinal gap 29 which runs in the x-direction is provided on one side, and a gap section 41 which is parallel to the longitudinal gap is provided on the other side of the reference opening 23. In this case, for manufacturing reasons, the gap section 41 is integrated directly with the cutout 25, which is intended to hold the coupling section for the optical waveguides.

As can clearly be seen from FIG. 15, the elastic section has an H-shaped configuration. The webs 31 of the H are formed with the aid of compensation cutouts 30, which run along the x-direction and are each arranged between the longitudinal gap 29 and the gap section 41. In order to allow the longitudinal gap 29 to be produced more easily, a hole 40 is provided, with whose aid the longitudinal gap can be manufactured, for example by means of spark-erosion processes. Base plates composed of metallic materials will be particularly suitable for this purpose. It is, of course, feasible for the gap section 41 to be in the form of a separate cutout, like the longitudinal gap 29. An arrangement such as this is shown in FIG. 14a.

FIGS. 16 and 17 show a cap-like housing connection 42 for an interferometer, in which a base plate 22 for a plug connection has been inserted. As can be seen from the figures, the base plate 22 may be inserted in a rotationally symmetrical form into a corresponding holder in the housing connection. A circular base plate such as this can therefore be connected to an interferometer in a precise manner.

Alternative embodiments of the plug connection as described above would, of course, also be feasible. In particular, it will be feasible to use the plug connection for a plug connection of a male and of a female plug part. The plug parts could, of course, also be hermaphroditic. For example, it would be feasible for the female plug to be designed conventionally and for the male plug to be designed on the basis of a refinement according to the invention.

1. A plug connection for producing an optical plug connection to an optical multiple-fiber plug part (2, 3), with the plug part (2, 3) having at least two essentially identical, preferably rotationally symmetrical, guide means (4, 5) which are arranged at a distance from one another and run parallel, with the plug connection (1) having first and second matching means (6, 7, 8, 9) which are arranged on one end face (17) for holding the guide means with an accurate fit, with the matching means each having at least one matching section (PA1, PA2) which extends on a longitudinal axis and interacts by means of a complementary guide means, characterized in that the first and second matching means are designed differently such that the longitudinal axis of the matching section (PA1) of the first matching means (6, 8) was longer than the matching section (PA2) of the second matching means (7, 9).

2. The plug connection in particular as claimed in claim 1, for producing an optical plug connection, having an optical multiple-fiber plug part (2, 3), with the plug part (2, 3) having at least two essentially identical, preferably rotationally symmetrical, guide means (4, 5) which are arranged at a distance from one another and run parallel, with the plug connection (1) having first and second matching means (6, 7, 8, 9) which are arranged on one end face (17) for holding the guide means with an accurate fit, with the matching means each having at least one matching section (PA1, PA2) which extends on a longitudinal axis and interacts by means of a complementary guide means, characterized in that the matching means (6, 7, 8, 9) are designed such that, during insertion of the plug part (2, 3), the associated guide means (4, 5) of the plug part first of all act on the first matching means (6, 8) and act on the second matching means (7, 9) only after an insertion distance has been exceeded, in order to form a fit.

3. The plug connection as claimed in claim 1, characterized in that the first matching means (6, 8) are designed such that the complementary guide means (4, 5) can be held with an accurate fit over approximately the entire insertion depth.

4. The plug connection as claimed in claim 1, for a male plug part (2) having essentially cylindrical guide pins (10) as guide means, characterized in that the first matching means (6) is a matching hole (11) for holding the complementary guide pin, as a result of which the guide pin (10) of the plug part (2) can be held with an accurate fit over approximately the entire insertion depth (L) and in that the second matching means is an opening (12) for holding the complementary guide pin, and its internal contour has a concave longitudinal section, thus defining an approximately linear contact with the complementary guide pin (10) or with the internal contour having a cylindrical section (13), thus defining a contact surface with the complementary guide pin (10).

5. The plug connection as claimed in claim 1, for a male plug part (2) having essentially cylindrical guide pins (10) as guide means, characterized in that the second matching means (7) is an opening (12) which, for simple insertion of the guide pin, has a cylindrical insertion section (38) which, together with the outer casing of the guide pin (10) defines an annular gap, and in that the insertion section (38) has a second section (39) adjacent to it, in which, in a limit position, the guide pin (10) can be held with an accurate fit.

6. The plug connection as claimed in claim 1, for a female plug part (3) with guide holes (14) as guide means, characterized in that the first and second matching means (8, 9) are matching pins (15, 16), with the second matching pin (16) which forms the second matching means being shorter, measured from the end face (17), than the first matching pin (15) which forms the first matching means.

7. The plug connection as claimed in claim 6, characterized in that the length (L2) of the second matching pin (16) is at most 90%, preferably at most 70%, and particularly preferably at most 50%, of the length (L1) of the first matching pin (15) with respect to the end face (17).

8. The plug connection as claimed in claim 6, characterized in that the first matching pin (15) is essentially cylindrical, and in that the free end of the second matching pin (16) is formed by a head part (18), with a taper (19) being provided at least between the head part (18) and the end face (17).

9. The plug connection as claimed in claim 6, characterized in that both matching pins (16) have a holding section (36) for holding a corresponding opening (23, 24) in a base plate (21).

10. The plug connection as claimed in claim 8, characterized in that the head part (18) being approximately dome shaped, thus defining a preferably approximately linear contact with the complementary guide hole (14), and in that the head part (18) has a cylindrical section (20), thus defining an area contact with the complementary guide hole (14).

11. The plug connection as claimed in claim 1, characterized in that, in order to fix the matching means (6, 7, 8, 9), the plug connection has a base plate (21) with a coupling cutout (25) for holding a coupling section (26) of the plug part (2, 3).

12. The plug connection as claimed in claim 11, characterized in that the base plate (21) is composed of metallic material.

13. The plug connection as claimed in claim 11, characterized in that the base plate (21) has an elastic section (22) which is associated with at least one matching means (6, 7, 8, 9), which is designed to be elastic such that, during connection of a plug part (2, 3), one matching means (8, 9) can be moved in order to compensate for dimensional discrepancies between the matching means and the guide means (4, 5) of the plug part.

14. The plug connection as claimed in claim 11, characterized in that the base plate (21) has a reference opening (24), which is arranged in a relatively rigid section, in order to fix either the first or the second matching means (6, 8) and in that a second opening (23) is provided for the other matching means (8, 9) and is arranged in an elastic section (22).

15. The plug connection as claimed in claim 14, characterized in that, in order to achieve the elastic section (22), the second opening (23) is arranged between at least two apertures (29, 41), into which run transversely with respect to an axis on which the two openings (23, 24) are located.

16. The plug connection as claimed in claim 15, characterized in that a compensation cutout (30) is arranged on each of the two sides of the second opening (23) between the apertures (29, 41), thus forming narrow webs (31).

17. The plug connection as claimed in claim 14, characterized in that pins (15, 16) are inserted into the first opening (24) and into the second opening (23), and form the first and second matching means.

18. An interferometer for measuring the surface topography of the multiple-fiber plug parts (2, 3), which have a plurality of optical waveguides (27) arranged parallel, having at least one plug connection (1) as claimed in claim 1.
